(19) United States
(12) Patent Application Publication
(10) Pub. No.: US 2003/0081560 A1
(43) Pub. Date: May 1, 2003

(54) Load test system for video data distributing server

(75) Inventor: Yoshizou Honda, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Ando Electric Co., Ltd.

(21) Appl. No.: 10/281,858

(22) Filed: Oct. 28, 2002

(30) Foreign Application Priority Data
Oct. 30, 2001 (JP) P2001-333184

(51) Int. Cl. H04L 12/26

(52) U.S. Cl. 370/252

(57) ABSTRACT

A load test system for the video data distributing server, by which the quality of distribution to all clients can be monitored without decreasing the number of simultaneous accesses. The load test system, inserted between real clients and a video data distributing server, comprises pseudo clients having a pseudo access generator for reproducing distribution request packets sent to the video data distributing server; a response section for sending response packets to the video data distributing server; and a manager for controlling each process of the load test and for collecting, analyzing, and displaying data. The system also has a packet quality monitor for monitoring a state of video data transmission by capturing packets communicated between the load test system and the video data distributing server. The monitored results are sent to the manager, and the quality of video images is evaluated based on the data analyzed by the manager.

### BACKGROUND OF THE INVENTION

1. Field of the Invention

The present invention relates to a load test system for a video data distributing server, and in particular, relates to a technique for monitoring video data packets corresponding to an imposed load and estimating the quality of distribution.

2. Description of the Related Art

As is conventionally known, in a video data streaming distribution service, a video data distributing server streams and distributes video data, in parallel, to a plurality of clients who issue a request for video data distribution.

The transmitted video data (i.e., encoded video codes) in the video data streaming distribution are typically compressed. However, the amount of the compressed data is still large, and parallel processing is employed in several portions such as the processor, the storage device, and the data transmitting device of the video data distributing server.

In the load test for such a video data distributing server, a few tens of computers are provided as clients, and a plurality of clients simultaneously access the video data distributing server as an object to be tested, so as to test whether the distribution service is normally performed to the accessed clients.

In another testing method, a plurality of distribution requesting programs and data receiving programs are loaded in parallel in each computer as a client, so as to increase the number of loads which are simultaneously imposed on the video data distributing server.

In order to perform the test by using a few tens of computers, a great deal of preparation, relating to arrangement, setting, connection, installation, starting, operation, place, electrical power, air conditioning, and the like, is necessary. However, the frequency of use of such an arrangement for the test is relatively small, and the efficiency of the system is therefore low.

In addition, the amount of the received video encoded data, which are to be decoded and displayed, is very large. Therefore, even if a plurality of distribution programs or data receiving programs are loaded in parallel, a dozen parallel operations or the like are the actual limit for a single computer to perform, and thus the total number of parallel operations, which can be simultaneously performed, is a few hundred or the like.

In order to increase the number of simultaneous parallel operations or decrease the number of the computers, another method is known in which a large number of pseudo client software processes (called “pseudo clients” hereinbelow) are operated instead of operating the distribution requesting programs and the data receiving programs, where the pseudo clients function as a lower load on the client computer.

A concrete example of such a method will be explained below, by referring to FIG. 6 which is a diagram showing the structure of a conventional load test system for testing the video data distributing server.

As shown in FIG. 6, a distribution and synthesis device 603 is inserted between a client 602 and a video data distributing server 601, and an access generating device 604 is connected to the distribution and synthesis device 603. The distribution and synthesis device 603 may be a hub in a LAN (local area network).

The access generating device 604 captures a distribution request packet sent from the client 602 to the video data distributing server 601 and stores data of timing of the issue of the distribution request packet. The access generating device 604 then reproduces packets corresponding to a number of pseudo clients, where each packet has a different value, transferred from the original value, for indicating an address, a user name, or a client name. The access generating device 604 sends the reproduced packets to the video data distributing server 601 at specific timings.

In this case, the video data distributing server 601 recognizes that the server simultaneously receives the distributing request packets from many clients, and corresponding processes for distributing video data are simultaneously started. The data receiving situation of the client 602, which receives the video data, is monitored by a quality monitor 605 so as to test and determine a limit for maintaining specific quality of video data distribution, that is, to determine when the quality of data distribution is degraded if the number of the simultaneous accesses increases.

However, the above-explained conventional load test system for the video data distributing server has the following first and second problems:

The first problem relates to the response of the client. Here, two methods are known for distributing video data by using the video data distributing server. In the first method, when a distribution request is received by the server, designated contents (i.e., video data) are continuously distributed until all the contents are distributed. In the second method, the distribution is continued while the response from the client is continued.

That is, in order that the client terminates the data reception after issuing the distribution request, the above second method employs a process of terminating the video data distribution when the video data distributing server receives no intermittent response for a specific time. This method is generally used in the latest networks, so as to efficiently use resources not only in a stable environment in which a termination request issued from the client is always normally received by the video data distributing server, but also in environments in which (i) packet loss may occur, (ii) the client (computer) may be stopped, (iii) an erroneous operation may be performed, or the like.

In an improved method of the above second method, a value indicating the packet loss rate (i.e., the rate of packets which were not decoded and used) is included in the response packet from the client. Accordingly, even if the throughput of a router or a specific network segment between the client and the video data distributing server temporarily decreases, the video frame may be thinned out or the image quality may be degraded so as to send video data at a decreased encoding rate. Accordingly, it is possible to prevent loss of video data caused by packet loss.

In this case, the video data distributing server performs dynamic distribution by reading out the packet loss rate included in the response packet and decreasing the encoding rate according to the read-out value. An example of such a response packet is described in RTCP (real-time transport control protocol) defined by the RFC1889 standard in IETF (Internet engineering task force).

On the other hand, in order to calculate the packet loss rate at the client side, a method is known in which a sequence number is added to each video data packet to be sent. When using this method, the client detects the absence of any sequence number, and the ratio of the number of packets, whose sequence numbers are absent, to the increment of the sequence number for the packets which have been received for a specific period indicates the packet loss rate, which can be easily calculated using a computer. An example of such a packet, to which the sequence number is added, is described in RTP (real-time transport protocol) defined by the RFC1889 standard in IETF.

When video data distribution is performed using a protocol such as RTP, RTCP, or the like, the above-explained conventional load test system for the video data distributing server can issue a number of distribution requests. However, the system does not have a function of sending a response packet of each of several clients to the video data distributing server, so that a period during which the server receives no response is produced and the distribution from the server is terminated. In this case, the load is not continued, and thus the load test cannot be performed.

The second problem is that the quality of distribution for each of the clients is unclear. In the above-explained load test system for the video data distributing server, the quality of distribution is monitored only by a single client. However, the quality of the distribution of the video data distributing server is not always equal between a number of clients, and the quality of distribution to a specific client may be relatively degraded.

Therefore, while only a single client is monitored, (i) degradation of the quality of distribution which is simultaneously provided to any other client is overlooked, or (ii) the test is repeated several times so as to detect and not overlook such degradation, thereby reducing the efficiency of the system.

Additionally, in order to simultaneously monitor the quality of distribution to a number of clients, the amount of unused computer resource, which can be used for the monitoring operation, should be large.

Furthermore, a simple method is required for monitoring the quality of packet distribution or the quality of distributed video image.

### SUMMARY OF THE INVENTION

In consideration of the above circumstances, an object of the present invention is to provide a load test system for the video data distributing server, by which the quality of distribution to all the clients can be monitored without decreasing the number of simultaneous accesses.

Therefore, the present invention provides a load test system, inserted between real clients and a video data distributing server, for performing a load test for the video data distributing server, comprising:

pseudo clients having:

a pseudo access generator for reproducing distribution request packets by rewriting distribution request packets from the real clients, and sending the reproduced packets to the video data distributing server;

a response section for sending response packets to the video data distributing server; and

a manager for controlling each process of the load test and for collecting, analyzing, and displaying data relating to the load performance of the video data distributing server, and

a packet quality monitor for monitoring a state of video data transmission by capturing packets communicated between the load test system and the video data distributing server,

wherein the packet quality monitor sends monitored results to the manager; and

the quality of video images, which correspond to the video data distributed from the video data distributing server to the pseudo clients, is evaluated based on the data analyzed and displayed by the manager.

According to the above structure, it is possible to realize a load test system for the video data distributing server, by which the quality of distribution to all clients can be monitored without decreasing the number of simultaneous accesses.

In a typical example, the packets reproduced by the pseudo access generator are pseudo distribution request packets which are sent to the video data distributing server;

the response packets sent by the response section to the video data distributing server are pseudo response packets, each including a packet loss rate with respect to each pseudo client;

the video data distributing server starts video data distribution processes in response to the pseudo distribution request packets, and continues the video data distribution according to the pseudo response packets sent from the response section;

the packets captured by the packet quality monitor are the pseudo response packets;

the packet quality monitor has a packet loss rate extracting section for extracting the packet loss rate with respect to each pseudo client from each pseudo response packet, and sends the extracted packet loss rate to the manager; and

the manager calculates the number of packets received by each pseudo client or a distribution bandwidth with respect to each pseudo client, based on the packet loss rate.

According to this structure, the quality of distribution of packets to a number of clients can be monitored, and the limit at which the quality of distribution to any client is degraded can be evaluated.

In another typical example, the packets reproduced by the pseudo access generator are pseudo distribution request packets which are sent to the video data distributing server;

the video data distributing server sends each pseudo client video data packets to which a series of sequence numbers are added;

the packets captured by the packet quality monitor are the video data packets;

the packet quality monitor has a sequence number extracting section for extracting the sequence numbers with respect to each pseudo client from the video data packets; and

the manager calculates the number of packets received by each pseudo client or a distribution bandwidth with respect to each pseudo client, based on a packet loss rate with respect to each pseudo client, where the packet loss rate is calculated by detecting absence of any sequence number.

According to this structure in which a sequence number is added to each video data packet, the video data packets are captured to extract each sequence number, and the packet loss rate is calculated by detecting absence of any sequence number, thereby calculating the number of packets received by each pseudo client or the distribution bandwidth with respect to each pseudo client. Therefore, the quality of distribution of packets can be monitored without referring to response packets which include the packet loss rates.

The present invention also provides a load test system, inserted between real clients and a video data distributing server, for performing a load test for the video data distributing server, comprising:

pseudo clients having:

a pseudo access generator for reproducing distribution request packets by rewriting distribution request packets from the real clients, and sending the reproduced packets to the video data distributing server; and

a manager for controlling each process of the load test and for collecting, analyzing, and displaying data relating to the load performance of the video data distributing server, and

a packet quality monitor for monitoring a state of video data transmission by capturing packets communicated between the load test system and the video data distributing server, the packet quality monitor including:

a response section for sending response packets to the video data distributing server,

wherein the packet quality monitor sends monitored results to the manager; and

the quality of video images, which correspond to the video data distributed from the video data distributing server to the pseudo clients, is evaluated based on the data analyzed and displayed by the manager.

According to the above structure, it is possible to realize a load test system for the video data distributing server, by which the quality of distribution to all clients can be monitored without decreasing the number of simultaneous accesses.

As a typical example, the packets reproduced by the pseudo access generator are pseudo distribution request packets which are sent to the video data distributing server;

the video data distributing server sends each pseudo client video data packets to which a series of sequence numbers are added;

the packets captured by the packet quality monitor are the video data packets;

the packet quality monitor has a sequence number extracting section for extracting the sequence numbers with respect to each pseudo client from the video data packets;

the packet quality monitor calculates a packet loss rate with respect to each pseudo client by detecting absence of any sequence number; and

the response packets sent by the response section to the video data distributing server are pseudo response packets, each including the calculated packet loss rate with respect to the corresponding pseudo client.

According to this structure in which a sequence number is added to each video data packet, the video data packets are captured to extract each sequence number, the packet loss rate is calculated by detecting absence of any sequence number, and the pseudo response packets, each including the calculated packet loss rate, are produced and sent to the video data distributing server. Therefore, it is unnecessary to provide a pseudo response section in advance.

In the above-explained load test systems, the manager may evaluate a video frame loss rate with respect to each pseudo client by using a conversion table for determining the video frame loss rate from the packet loss rate of the pseudo client.

In this case, the video frame loss rate can be evaluated by using the conversion table, thereby evaluating the load performance of the video data distributing server based on the quality of the video image.

Also in this case, the load test system may further comprise:

a pseudo network inserted between the real clients and the video data distributing server, where a predetermined packet loss rate is assigned to the pseudo network and the packet loss rate is variable; and

a client quality monitor for calculating a video frame loss rate with respect to video data received by the real clients,

wherein the video frame loss rates, calculated while the packet loss rate is varied, and the corresponding packet loss rates are stored in the conversion table.

According to this structure, the packet loss rate is variable in the pseudo network, the client quality monitor calculates the video frame loss rate with respect to the video data received by the real clients, and the video frame loss rates corresponds to different packet loss rates are stored. Therefore, the load performance of the video data distributing server can be evaluated based on the quality of the video image, which is evaluated by the packet loss rate.

In the above-explained load test systems, the packets captured by the packet quality monitor may be video data packets sent from the video data distributing server; and

the packet quality monitor has a video frame header extracting section for extracting a video frame header, reads out a video frame number included in the video frame header, calculates a video frame loss rate by detecting absence of any image frame number.

According to this structure, the ratio of the number of lost video frames to the increment of the video frame number for a specific period can be the video frame loss rate. Therefore, the load performance of the video data distributing server can be evaluated based on the quality of the video image.

### BRIEF DESCRIPTION OF THE DRAWINGS

FIG. 1 is a diagram showing the structure of the load test system for testing the video data distributing server as the first embodiment of the present invention.

FIG. 2 is a diagram showing the structure of the load test system for testing the video data distributing server as the second embodiment of the present invention.

FIG. 3 is a diagram showing the structure of the load test system for testing the video data distributing server as the third embodiment of the present invention.

FIG. 4 is a diagram showing the structure of the load test system for testing the video data distributing server as the fourth embodiment of the present invention.

FIG. 5 is a diagram showing the structure of the load test system for testing the video data distributing server as the fifth embodiment of the present invention.

FIG. 6 is a diagram showing the structure of a conventional load test system for testing the video data distributing server.

### DESCRIPTION OF THE PREFERRED EMBODIMENTS

Hereinafter, embodiments according to the present invention will be explained with reference to the drawings.

First Embodiment

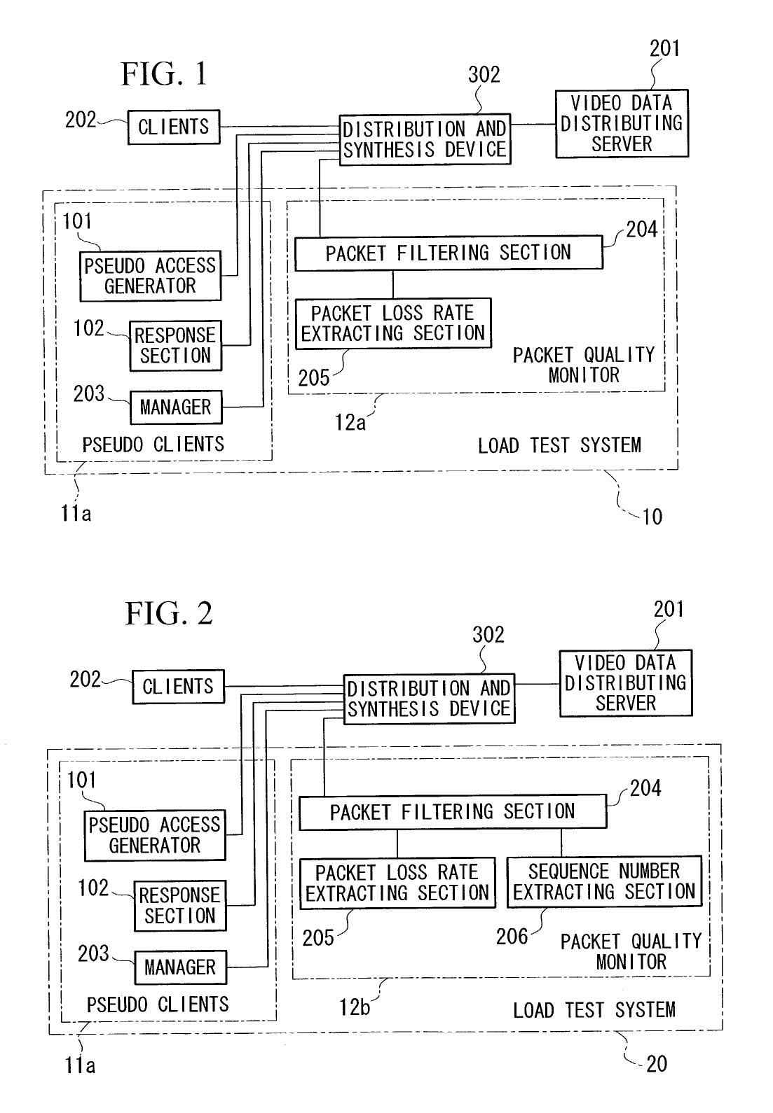

FIG. 1 is a diagram showing the structure of the load test system 10 for testing the video data distributing server as the first embodiment of the present invention. The structure and function of this system will be explained by referring to FIG. 1.

As shown in FIG. 1, the load test system 10 is provided between a video data distributing server 201 and a plurality of clients 202, and the load test system 10 has a function of evaluating the quality and performance of video or moving images which are distributed from the video data distributing server 201 to the clients 202.

The load test system 10 comprises (i) a plurality of pseudo clients 11a which have a pseudo access generator 101, a response section 102, and a manager 203, and (ii) a packet quality monitor 12a which has a packet filtering section 204 and a packet loss rate extracting section 205.

In FIG. 1, the clients 202 access the video data distributing server 201 so that the video data streaming service is provided to the clients 202. A distribution and synthesis device 302 is inserted between the clients 202 and the video data distributing server 201, and the pseudo access generator 101 is connected to this distribution and synthesis device 302.

The pseudo access generator 101 has a function of capturing distribution request packets, which are sent from the clients 202 to the video data distributing server 201. The pseudo access generator 101 then reproduces packets by rewriting the address, the user name, or the client name, and sends the reproduced packets to the video data distributing server 201.

The pseudo access generator 101 then connects the response section 102 and the manager 203 to the distribution and synthesis device 302, and the response section 102 continuously sends the video data distributing server 201 response packets so as to respond to the video data distribution from the server.

Here, the response packet includes data which indicates the packet loss rate. The response packet may have a function defined by the above-explained RTCP. The manager 203 controls each process of the load test for the video data distributing server, collects data of relevant sections so as to analyze results of the test or display a graph which indicates the results.

If the response section 102 and the pseudo access generator 101 can be more easily realized by using the same computer, then a plurality of computers, each including the response section 102 and the pseudo access generator 101, may be provided so as to increase the number of clients which simultaneously access the server.

This case corresponds to a conventional case using a load generating tool for the video data distributing server, in which the pseudo access generator and the response section cannot be separated. The load test can be performed by adding a section for monitoring the quality of distribution, to the structure of the pseudo clients 11a.

As shown in FIG. 4 which will be explained below, the quality of the clients 202 can be monitored by adding a client quality monitor 301.

In the next process, the packet quality monitor 12a is connected to the distribution and synthesis device 302. The packet quality monitor 12a filters data input into the monitor 12a by using the packet filtering section 204, so as to receive only the response packets. The packet quality monitor 12a extracts the value indicating the packet loss rate from each received response packet by using the packet loss rate extracting section 205. The packet quality monitor 12a then stores the extracted value and the corresponding client name, and sends the value and the client name to the manager 203. That is, the manager 203 receives or collects the data.

Therefore, it is possible to monitor the quality of data distribution to a plurality of pseudo clients 11a from the video data distributing server 201.

In the example of the response packet defined by RTCP, the length of the response packet corresponding to any one of the clients 202 is approximately a few tens of bytes. Therefore, if the response packet is issued at an interval of approximately a few seconds, the total length of the response packet is a few kilobytes to a few hundred kilobytes during video data distribution for a few hours. Therefore, the commercially-available computer resource can afford to store and process the response packets from, for example, 1000 clients.

The process of the load test will be explained below. First, the clients 202 send distribution request packets to the video data distributing server 201, and the video data distributing server 201 starts the video data distribution. This distribution is continued by transmitting the response packets until the distribution is normally completed. In this process, the pseudo access generator 101 generates a number of distribution request packets which are sent to the video data distributing server 201 under the control of the manager 203.

The video data distributing server 201 receives many accesses and starts video data distribution simultaneously to the relevant clients. The response section 102 calculates the packet loss rate for each pseudo client and sends the video data distributing server 201 a response packet which includes the calculated value. The packet quality monitor 12a receives this response packet and stores the packet loss rate of each of the pseudo clients 11a. The manager 203 collects the packet loss rates sent from the packet quality monitor 12a. When the video data distribution is completed, the number of the (pseudo) clients which simultaneously access is changed and the processes from the pseudo accessing to the collection of the packet loss rates are repeated.

An amount of packets to be received and a suitable distribution bandwidth are predetermined for each number of simultaneous clients (i.e., simultaneously-accessing pseudo clients). The manager 203 calculates, for each number of simultaneous clients, the number of packets received by each pseudo client or the distribution bandwidth of each pseudo client, based on the packet loss rate. It is possible to determine, based on the calculated results, whether the predetermined amount of packets or distribution bandwidth is acquired. If the predetermined amount or bandwidth is not acquired, the load performance of the video data distributing server 201 is insufficient at the relevant number of simultaneous clients.

Second Embodiment

FIG. 2 is a diagram showing the structure of the load test system for the video data distributing server, as the second embodiment of the present invention. The structure and function of the load test system 20 in the second embodiment will be explained below with reference to FIG. 2.

In the following explanations with respect to the second embodiment, parts identical to those which were explained by referring to FIG. 1 are given identical or corresponding reference numerals, and explanations thereof are simplified or omitted.

As shown in FIG. 2, the packet quality monitor 12b of the present embodiment comprises a packet filtering section 204, a packet loss rate extracting section 205, and a sequence number extracting section 206.

In the present embodiment, a sequence number is assigned to each video data packet, and the response packet does not include the packet loss rate. The sequence number is extracted by the sequence number extracting section 206.

The video data packet to which the sequence number is added may be defined by the above-explained RTP. Instead of extracting the packet loss rate from the response packet, in the present embodiment, the video data packet is captured by the packet quality monitor 12b so as to detect the absence of any sequence number.

The ratio of the number of packets, whose sequence numbers are absent, to the increment of the sequence number for a specific period indicates the packet loss rate. The ratios of a plurality of pseudo clients 11a are calculated in the packet quality monitor 12b and are collected by the manager 203.

The number of the video data packets is larger than the number of the response packets by one order of magnitude (i.e., ten times or more). Therefore, large-scale processing is necessary for processing the video data packets in comparison with the case of processing only the response packets.

In the load test system 20 of the present embodiment, a process of calculating the packet loss rate according to the absence of the sequence number is necessary, so as to further calculate the number of packets received by each pseudo client, or the distribution bandwidth for each pseudo client. Therefore, the processes performed in the present embodiment are relatively heavy, and the following third embodiment may be employed so as to improve the efficiency of the system.

Third Embodiment

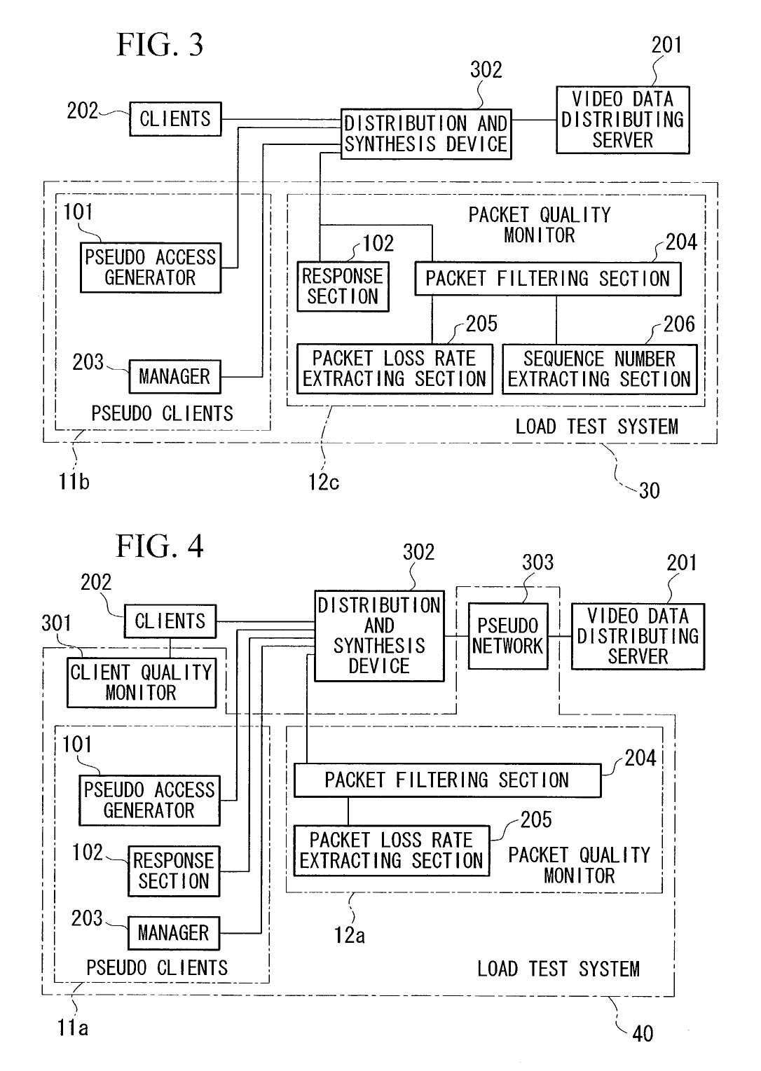

FIG. 3 is a diagram showing the structure of the load test system for the video data distributing server, as the third embodiment of the present invention. The structure and function of the load test system 30 in the third embodiment will be explained below with reference to FIG. 3.

In the following explanations with respect to the third embodiment, parts identical to those which were explained by referring to FIGS. 1 and 2 are given identical or corresponding reference numerals, and explanations thereof are simplified or omitted.

As shown in FIG. 3, in the load test system 30 in the present embodiment, the packet quality monitor 12c comprises a packet filtering section 204, a packet loss rate extracting section 205, a sequence number extracting section 206, and a response section 102, and the pseudo clients 11b comprises a pseudo access generator 101 and a manager 203. Therefore, the distinctive feature of the present invention in comparison with the first and second embodiments is that the response section 102 is included in the packet quality monitor 12c.

In the present embodiment, the response packet to be sent to the video data distributing server 201 is produced by using the device for capturing the video data packet, to which the sequence number is added. That is, the response packet is a pseudo response packet.

Similar to the second embodiment, in the present embodiment, the video data packet, to which the sequence number is added, is captured by the packet quality monitor 12c, so as to calculate the packet loss rate. Then, a response packet including the packet loss rate, which was written based on a specific format of the response packet, is sent to the video data distributing server 201.

In the above explanations, the rate at which the packets can be accurately distributed is an important point. However, the quality of the video image is not uniform at a packet loss rate, depending on the kind of the video data encoding technique or other conditions. Therefore, the limit point at which degradation of the quality of the video image starts may be preferably tested for each load.

When only a single client is monitored as in the conventional test system, the number of frames of the video image, which were not reproduced by the video decoder, is detected by a client quality monitor which is connected to the client. However, the video decoder consumes substantial computer resources by (i) temporarily storing (i.e., buffering) one or a few video frames, each frame requiring a memory area of a few megabytes, (ii) processing an algorithm of a large-scale operation such as conversion of a coefficient in the two-dimensional spatial frequency region into a spatially-distributed value, or the like. Therefore, the video decoder cannot be assigned to each of a number of clients.

Accordingly, it is necessary to employ a method for evaluating the quality of the video image by using less computer resources. Such a method can be realized by the present embodiment.

Fourth Embodiment

FIG. 4 is a diagram showing the structure of the load test system for the video data distributing server, as the fourth embodiment of the present invention. The structure and function of the load test system 40 in the fourth embodiment will be explained below with reference to FIG. 4.

In the following explanations with respect to the fourth embodiment, parts identical to those which were explained by referring to FIGS. 1 to 3 are given identical or corresponding reference numerals, and explanations thereof are simplified or omitted.

As shown in FIG. 4, the load test system 40 in the present embodiment basically employs the structure shown in FIG. 1 and further employs a pseudo network 303 inserted between the clients 202 and the video data distributing server 201. The present embodiment is provided for evaluating a video frame loss rate based on the packet loss rate.

Under the control of the manager 203, the pseudo network 303 inserted between the clients 202 and the video data distributing server 201 can define any packet loss rate for video data which pass through the pseudo network 303. Such a pseudo network 303 may be called a network simulator.

The operation of the fourth embodiment will be explained below.

First, the packet loss rate of video data which pass through the pseudo network 303 is set to a specific value, and video data distribution is performed from the video data distributing server 201 to the clients 202. The client quality monitor 301 calculates the video frame loss rate for the video data distribution.

Similarly, under different packet loss rates which are defined in turn, the video frame loss rates are calculated, and the manager 203 collects data of the video frame loss rates. In this process, a number of distribution request packets are generated by the pseudo access generator 101 and are sent to the video data distributing server 201, so that a number of video data distribution processes are simultaneously started.

The packet quality monitor 12a extracts the packet loss rate included in each response packet, and the manager 203 collects the packet loss rates with respect to the pseudo clients 11a.

A suitable video frame loss rate for the video data distribution is predetermined.

The manager 203 uses corresponding relationships between the different packet loss rates (which are assigned to the pseudo network 303) and the corresponding calculated video frame loss rates, as a conversion table. The manager 203 determines, for each number of simultaneous clients, the video frame loss rate with respect to each pseudo client, based on the packet loss rate of the pseudo client by using the conversion table.

If the determined video frame loss rate is inferior to the predetermined video frame loss rate, the load performance relating to the quality of video images of the video data distributing server 201 is insufficient at the relevant number of simultaneous clients.

Fifth Embodiment

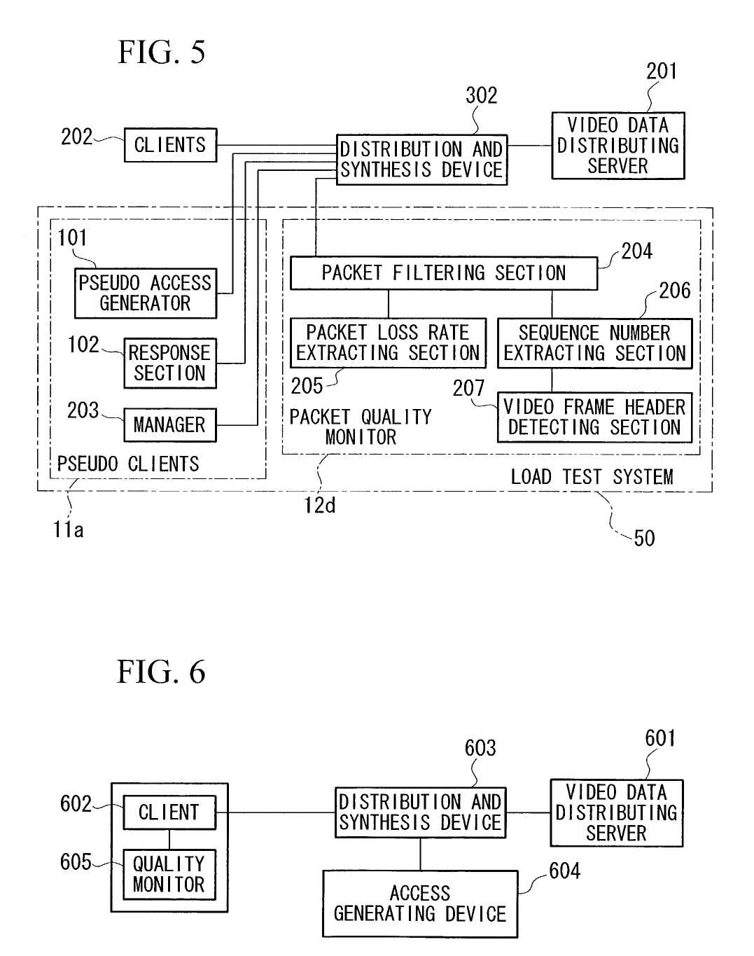

FIG. 5 is a diagram showing the structure of the load test system for the video data distributing server, as the fifth embodiment of the present invention. The structure and function of the load test system 50 in the fifth embodiment will be explained below with reference to FIG. 5.

In the following explanations with respect to the fifth embodiment, parts identical to those which were explained by referring to FIGS. 1 to 4 are given identical or corresponding reference numerals, and explanations thereof are simplified or omitted.

As shown in FIG. 5, the load test system 50 in the present embodiment suitably uses the structures explained in the first to fourth embodiments, and further employs a video frame header detecting section 207 in the packet quality monitor 12c.

The present embodiment is provided for calculating the video frame loss rate and evaluating the load performance of the video data distributing server based on the calculated results.

In the present embodiment, the packet quality monitor 12c captures each video data packet, to which a sequence number is added. As for the video data packets, the packet quality monitor 12c detects the absence of any sequence number so as to calculate the packet loss rate, and extracts a video frame header by using the video frame header detecting section 207, so as to read out the video frame number included in the header.

The packet quality monitor 12c further detects the absence of any image frame number. The video frame header corresponding to any absent video frame number is not received by the relevant pseudo client 11a; thus, it is determined that no video frame is reproduced in this case. Accordingly, video frame loss is measured as an estimated value.

Here, the ratio of the number of lost video frames to the increment of the video frame number for a specific period indicates the video frame loss rate. The manager 203 collects the video frame loss rates and the packet loss rates of a number of pseudo clients 11a.

In the above embodiments, the pseudo network 303 is used only on the fourth embodiment (refer to FIG. 4). However, the other embodiments may use a similar pseudo network 303, so as to evaluate the performance with respect to the simultaneous clients by producing pseudo-variation of the distribution bandwidth by using the pseudo network 303. That is, as for each of the different distribution bandwidths, the load test may be performed while changing the number of simultaneous clients.

Accordingly, it is possible to detect the limit point at which either one of the video data distributing server 201 and the distribution bandwidth indicates the load limit. That is, the so-called “bottle neck” can be determined, and it is possible to target portions which should be reinforced so as to improve the performance. Therefore, efficient system investment can be performed.

What is claimed is:

1. A load test system, inserted between real clients and a video data distributing server, for performing a load test for the video data distributing server, comprising:
pseudo clients having:
a pseudo access generator for reproducing distribution request packets by rewriting distribution request packets from the real clients, and sending the reproduced packets to the video data distributing server;
a response section for sending response packets to the video data distributing server; and
a manager for controlling each process of the load test and for collecting, analyzing, and displaying data relating to the load performance of the video data distributing server, and
a packet quality monitor for monitoring a state of video data transmission by capturing packets communicated between the load test system and the video data distributing server,
wherein the packet quality monitor sends monitored results to the manager; and
the quality of video images, which correspond to the video data distributed from the video data distributing server to the pseudo clients, is evaluated based on the data analyzed and displayed by the manager.

2. A load test system as claimed in claim 1, wherein:
the packets reproduced by the pseudo access generator are pseudo distribution request packets which are sent to the video data distributing server;
the response packets sent by the response section to the video data distributing server are pseudo response packets, each including a packet loss rate with respect to each pseudo client;
the video data distributing server starts video data distribution processes in response to the pseudo distribution request packets, and continues the video data distribution according to the pseudo response packets sent from the response section;
the packets captured by the packet quality monitor are the pseudo response packets;
the packet quality monitor has a packet loss rate extracting section for extracting the packet loss rate with respect to each pseudo client from each pseudo response packet, and sends the extracted packet loss rate to the manager; and
the manager calculates the number of packets received by each pseudo client or a distribution bandwidth with respect to each pseudo client, based on the packet loss rate.

3. A load test system as claimed in claim 1, wherein:
the packets reproduced by the pseudo access generator are pseudo distribution request packets which are sent to the video data distributing server;
the video data distributing server sends each pseudo client video data packets to which a series of sequence numbers are added;
the packets captured by the packet quality monitor are the video data packets;
the packet quality monitor has a sequence number extracting section for extracting the sequence numbers with respect to each pseudo client from the video data packets; and
the manager calculates the number of packets received by each pseudo client or a distribution bandwidth with respect to each pseudo client, based on a packet loss rate with respect to each pseudo client, where the packet loss rate is calculated by detecting absence of any sequence number.

4. A load test system, inserted between real clients and a video data distributing server, for performing a load test for the video data distributing server, comprising:
pseudo clients having:
a pseudo access generator for reproducing distribution request packets by rewriting distribution request packets from the real clients, and sending the reproduced packets to the video data distributing server; and
a manager for controlling each process of the load test and for collecting, analyzing, and displaying data relating to the load performance of the video data distributing server, and
a packet quality monitor for monitoring a state of video data transmission by capturing packets communicated between the load test system and the video data distributing server, the packet quality monitor including:
a response section for sending response packets to the video data distributing server,
wherein the packet quality monitor sends monitored results to the manager; and
the quality of video images, which correspond to the video data distributed from the video data distributing server to the pseudo clients, is evaluated based on the data analyzed and displayed by the manager.

5. A load test system as claimed in claim 4, wherein:
the packets reproduced by the pseudo access generator are pseudo distribution request packets which are sent to the video data distributing server;
the video data distributing server sends each pseudo client video data packets to which a series of sequence numbers are added;
the packets captured by the packet quality monitor are the video data packets;
the packet quality monitor has a sequence number extracting section for extracting the sequence numbers with respect to each pseudo client from the video data packets;
the packet quality monitor calculates a packet loss rate with respect to each pseudo client by detecting absence of any sequence number; and
the response packets sent by the response section to the video data distributing server are pseudo response packets, each including the calculated packet loss rate with respect to the corresponding pseudo client.

6. A load test system as claimed in claim 1, wherein:
the manager evaluates a video frame loss rate with respect to each pseudo client by using a conversion table for determining the video frame loss rate from the packet loss rate of the pseudo client.

7. A load test system as claimed in claim 5, wherein:
the manager evaluates a video frame loss rate with respect to each pseudo client by using a conversion table for determining the video frame loss rate from the packet loss rate of the pseudo client.

8. A load test system as claimed in claim 6, further comprising:
a pseudo network inserted between the real clients and the video data distributing server, where a predetermined packet loss rate is assigned to the pseudo network and the packet loss rate is variable; and
a client quality monitor for calculating a video frame loss rate with respect to video data received by the real clients,
wherein the video frame loss rates, calculated while the packet loss rate is varied, and the corresponding packet loss rates are stored in the conversion table.

9. A load test system as claimed in claim 7, further comprising:
a pseudo network inserted between the real clients and the video data distributing server, where a predetermined packet loss rate is assigned to the pseudo network and the packet loss rate is variable; and
a client quality monitor for calculating a video frame loss rate with respect to video data received by the real clients,
wherein the video frame loss rates, calculated while the packet loss rate is varied, and the corresponding packet loss rates are stored in the conversion table.

10. A load test system as claimed in claim 1, wherein:
the packets captured by the packet quality monitor are video data packets sent from the video data distributing server; and
the packet quality monitor has a video frame header extracting section for extracting a video frame header, reads out a video frame number included in the video frame header, calculates a video frame loss rate by detecting absence of any image frame number.

11. A load test system as claimed in claim 4, wherein:
the packets captured by the packet quality monitor are video data packets sent from the video data distributing server; and
the packet quality monitor has a video frame header extracting section for extracting a video frame header, reads out a video frame number included in the video frame header, and calculates a video frame loss rate by detecting absence of any image frame number.
